(19) United States
(12) Patent Application Publication
(10) Pub. No.: US 2006/0243924 A1
(43) Pub. Date: Nov. 2, 2006

(54) Shutter

(76) Inventor: Clayton Sampson, Upper Heyford (GB)

Correspondence Address: JOEL D. SKINNER, JR.;SKINNER AND ASSOCIATES, 212 COMMERCIAL ST., HUDSON, WI, 54016, US

(21) Appl. No.: 10/547,806

(22) PCT Filed: Feb. 27, 2004
(86) PCT No.: PCT/GB04/00787

§ 371 Date: May 19, 2006

(30) Foreign Application Priority Data
Mar. 1, 2003 (GB) 0304759.4

(51) Int. Cl. F21V 9/06

(52) U.S. Cl. 250/504 R

(57) ABSTRACT

A shutter for a light source is described, the shutter being switchable between a substantially opaque condition and a substantially transparent condition. In one embodiment the shutter comprises a layer of a liquid cyrstal material located between polarised elements, a control system being provided to control the orientation of the crystals of the layer. A shuttered light source incorporating the shutter is also discribed.

This arrangement relates to a shutter, and in particular to a shutter suitable for use in preventing or reducing the emission of light from a housing containing a light source.

Ultraviolet light is commonly used to assist in the curing of inks, adhesives, paints, varnishes or the like. In such applications, one or more UV light sources are positioned adjacent the medium to which the material to be cured has been applied. The light sources used in these applications typically comprise mercury arc lamps. Such lamps require a warm-up or burn in period after being switched on before the desired output frequency or frequencies are emitted thereby. Further, after use, a significant cool-down period must be provided before the lamp can be re-used or re-struck.

In order to control exposure times, to avoid damage to machinery, the material being cured or the medium to which material to be cured has been applied, and to reduce or avoid the risk of exposure to humans, it is desirable to be able to stop the emission of radiation. However, as mentioned above, simply turning off the light source may be undesirable. In order to allow control over radiation without requiring the light source to be switched off, it is known to provide mechanical shutters. These shutters typically take the form of an opaque barrier material sheet that can be moved between a stowed position and a position between the light source and the medium by an appropriate actuator mechanism. It will be appreciated that when located between the light source and the medium, irradiation of the medium by the light source is prevented. An alternative arrangement includes using an actuator mechanism to move the light source to a position adjacent an opaque barrier material, again to prevent irradiation of the medium by the light source.

The high heat levels generated during operation can result in failure of the actuator mechanism, and this is clearly undesirable.

Rather than provide a moveable shutter or fixed shutter position to which a light source can be moved, it is known to provide UV light sources designed to permit more rapid switching than can be achieved with typical mercury arc lamps. However, these types of lamp often do not have the same spectral output as a conventional mercury arc lamp, and this may impair their performance in curing materials.

It is an object to provide a shutter whereby the disadvantages described above may be reduced or overcome.

According to the present invention there is provided a shutter comprising a body switchable between a substantially opaque condition and a substantially transparent condition, relative to a predetermined frequency of radiation.

Such a shutter may be rigidly fixed relative to a light source or relative to a medium such that no additional actuator mechanism is required to control the position of the shutter.

The shutter may comprise two plane polarised elements, one of which is moveable relative to the other to switch the shutter between its substantially opaque and substantially transparent conditions.

Alternatively, the shutter may comprise a solid state shutter, for example comprising a plane polarised element and a medium, the polarisation of which can be switched to control whether the shutter is substantially opaque or substantially transparent. The medium may comprise, for example, a layer of a liquid crystal material, in which case a control system for controlling the current or voltage applied to the liquid crystal material and thereby control the orientation of the crystals is provided. A second plane polarised element may be provided, the controllable medium being located between the plane polarised elements

The control system is preferably arranged to allow parts of the shutter to be controlled independently of other parts thereof, such that the shutter may, at any given time, include one or more areas which are substantially opaque and one or more areas which are substantially transparent.

It will be appreciated that such an arrangement may be controlled so as to serve as a shutter and also to act, in effect, as a graduated filter allowing a larger intensity of radiation to be incident upon one part of a target area as compared to that incident upon another part thereof.

In use, the heat generated by the UV source may be such that it is desirable to provide a cooling system for the shutter. By way of example, cooling of the shutter may be achieved by causing a flow of air or water to pass over or adjacent the shutter.

The invention further relates to a shuttered light source comprising a light emitting device arranged to irradiate a target area, and a shutter of the type defined hereinbefore located between the light emitting device and the target area. The light emitting device is conveniently arranged to emit ultraviolet light. The light emitting device may be located within a housing having an opening formed therein, the shutter being located across or adjacent the opening to control the emission of light through the opening. The housing may include or be defined, in part, by a reflector arranged to reflect light towards the opening.

According to another aspect of the invention there is provided a shuttered light source having a filter through which at least a proportion of the radiation emitted by the light source passes, the filter being graduated such that the intensity of radiation incident upon one part of a target area differs from that at another part of the target area.

The filter may comprise a shutter of the type described hereinbefore. Alternatively, the filter may comprise a transparent substrate part or parts of which has or have been treated, for example by printing or etching, to render it or them less transmissive or opaque.

Where the shutter allows individual control over the pixels thereof, then the shutter may be controlled using software adapted to use digital raster image or RIP raster image data, or similar image creation or processing techniques in controlling which of the pixels should be opaque and which should be transparent at any given time to allow control over the UV curing dose applied to the image.

The invention will further be described, by way of example, with reference to the accompanying drawings, in which:

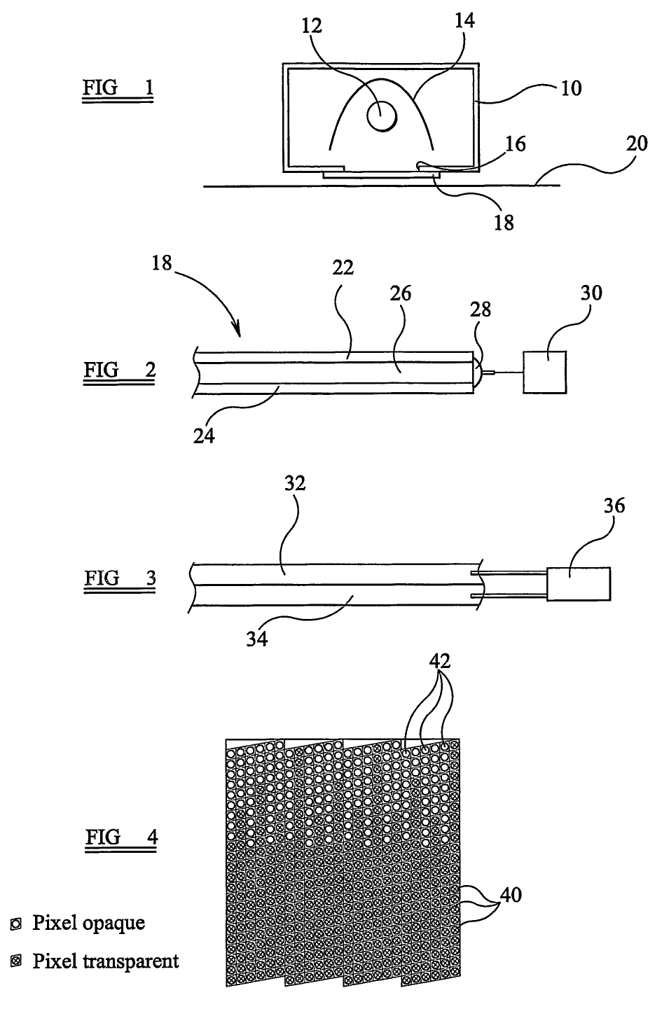

FIG. 1 is a diagrammatic view of a shuttered light source;

FIG. 2 is a diagrammatic sectional view illustrating a shutter in accordance with one embodiment of the invention;

FIG. 3 is a diagrammatic sectional view of an alternative shutter; and

FIG. 4 is a diagrammatic view illustrating one mode of operation of the shuttered light source of FIGS. 1 and 2.

The arrangement illustrated in FIG. 1 comprises a housing 10 within which is located a mercury arc lamp 12. A suitable control arrangement (not shown) for controlling and energising the mercury arc lamp 12 is provided. A reflector 14 is provided within the housing 10 to direct the light emitted by the mercury arc lamp 12 towards an opening 16 provided in the housing 10, and through the opening towards a target area. A shutter arrangement 18 is located across the opening 16 to control the emission of radiation from the housing 10 towards a medium 20 located at the target area. In the arrangement illustrated, the medium 20 is of relatively large dimensions compared to those of the housing 10 and as a result, in order to ensure that the full area of the medium 20 can be irradiated, either the housing 10 is arranged to be moveable over the medium 20, and/or the housing 10 is fixed and a suitable drive arrangement is provided to move the medium 20. It will be appreciated that, depending upon the application in which the invention is to be used, the housing 10 could be associated with, for example, the print head of an inkjet printer, the print head and the housing 10 being translatable across the medium 20, the medium 20 being moveable, in steps, past the print head and housing 10 thereby allowing the full surface area of the medium 20 be irradiated over a period of time.

The shutter arrangement 18 comprises first and second transparent members 22, 24 each of which is plane polarised. Although the members 22, 24 could take a range of forms, they conveniently take the form of sheets of glass or quartz. Located between the sheets 22, 24 is a layer 26 of a liquid crystal material. Electrodes 28 are provided around the layer 26, energisation of the electrodes 28 being controlled by a suitable control arrangement 30. In use, the control unit 30 controls the energisation of the electrodes 28 to control the orientation of the crystals of the layer 26 of liquid crystal material. Depending upon the type of liquid crystal material used, the sheets 22, 24 may be arranged such that the axes of polarisation thereof are parallel to one another, and such that when the electrodes 28 are de-energised light is able to be transmitted through the shutter arrangement 18, energisation of the electrodes 28 under the control of the control arrangement 30 causing the crystals of the liquid crystal material to align in such a direction that light transmission through the shutter arrangement 18 is no longer permitted. It will be appreciated, however, that other arrangements are also possible.

In use of the shuttered light source illustrated in FIG. 1 using the shutter arrangement 18 shown in FIG. 2, when it is desired to irradiate the medium 20, the control arrangement 30 is operated to control the shutter arrangement 18 such that the shutter arrangement is substantially transparent at least to the frequencies of ultraviolet light emitted by the light source 12. At times when the irradiation is no longer required, the control unit 30 is operated to render the shutter arrangement 18 substantially opaque at least to the ultraviolet frequencies of interest, thereby preventing irradiation of the medium 20.

Although in a relatively simple arrangement the control arrangement 30 may be arranged to control the shutter arrangement 18 such that the fill area of the shutter arrangement is either opaque or transparent at any given time, more complex arrangements are possible in which the control arrangement 30 controls the operation of the shutter arrangement 18 in such a manner that only selected parts of the shutter arrangement 18 are rendered transparent or substantially transparent at any given time. By way of example, where the light source is larger than as hereinbefore described, and extends over the full width of the medium and protrudes beyond the edges of the medium, then it may be desirable to ensure that the parts of the shutter arrangement 18 which extend beyond the edges of the medium remain opaque whilst the parts of the shutter arrangement located directly over the medium 20 can become transparent. Such an arrangement may be advantageous in that the exposure to radiation of anything other than the medium can be avoided. Further, even where the light source 10 extends only over the medium 20, rather than extending beyond the edges of the medium 20, there may situations where the area of the medium 20 to be irradiated is less than the full area thereof, for example if the medium has margins to which ink or another curable material has not been applied, in which case certain parts of the edge of the medium 20 may be shielded by ensuring that the associated parts of the shutter arrangement 18 remain substantially opaque. There may further be situations where it is desired to shield other parts of the medium 20 from radiation and it will be appreciated that by appropriate operation of the control arrangement 30, the shutter arrangement may be controlled in such a manner that the relevant part or parts of the shutter arrangement remain opaque, in use. For example, when used in a printing application, a dark part of an image may be formed be laying down black ink to a depth of up to 30 μm, lighter parts of the image having a relatively low density of ink dots, or even no ink at all. In order to avoid damage to the medium in areas in which little or no ink has been delivered, whilst allowing curing of the darker parts of the image, it may be desirable to use the technique mentioned hereinbefore.

Where the shutter arrangement 18 does not remain fixed relative to the medium 20, in use, then it will be appreciated that the control arrangement 30 may be required to modify those areas of the shutter arrangement 18 which are opaque and those areas that are transparent as the shutter arrangement is moving relative to the medium 20.

Depending upon the manner in which the shutter arrangement 18 is controlled, it may be possible to provide a sufficient number of independently controllable “pixels” in the shutter arrangement that, by appropriate control of the shutter arrangement and the pattern of the pixels rendered substantially opaque at any given time, the power output of the light source can be controlled. The power output variation achieved in this manner need not be distributed evenly over the medium, but rather, if desired, some parts of the medium may receive a different strength “dose” to other parts thereof.

One area in which it is known to use ultraviolet radiation is in the curing of ink delivered by an inkjet printer, for example of the drop on demand (DOD) traversing type. It is common, in such printers, for the medium being printed to be moved in steps smaller than the width of the area typically irradiated by a conventional UV light source, and for ink to be delivered over several passes or traverses of the print head relative to the medium. As a result, ink delivered during one of the earlier passes may be irradiated several times before leaving the area being irradiated, whereas ink delivered during one of the later passes may only be irradiated once. If the power output of the UV source is chosen to ensure that the ink delivered during one of the later passes is cured, then ink delivered during one of the earlier passes may be irradiated to such an extent that it degrades. Where the system of the present invention is used, then the shutter may be controlled in such a manner as to ensure that the ink delivered during the early passes initially receives only a relatively low dosage of UV radiation by ensuring that the part of the shutter located over this part of the medium contains only a relatively small area or proportion which is transparent. FIG. 4 illustrates a pixel configuration which may be used to achieve the effect, but it will be appreciated that a number of other configurations may be used within the scope of the invention.

In the arrangement shown in FIG. 4, the shutter has a plurality of individually controllable pixels switchable between a substantially transparent condition and a substantially opaque condition. In FIG. 4, pixels 40 are substantially transparent and pixels 42 are substantially opaque, this arrangement being achieved by appropriate control of the shutter. The effect of controlling the shutter to operate in this manner is to form, in effect, a graduated filter located between the light source and the target area such that whilst one part of the target area is subject to irradiation of relatively high intensity, other parts are subject to lower intensities or irradiation whatsoever.

As mentioned hereinbefore, other patterns of pixels may be used to achieve this effect.

Rather than use the shutter to serve as a filter, it is possible to use a separate filter component. This could, of course, take the form of a second component of construction similar to that of the shutter and controlled appropriately. Alternatively, a suitably graduated filter component may be located between the light source and the target area. By way of example, the filter may comprise a glass or quartz substrate to which ink has been applied or another treatment used to vary the transmissiveness of the substrate over the area thereof in a desired pattern.

FIG. 3 illustrates an alternative to the shutter arrangement illustrated in FIG. 2. In the shutter arrangement shown in FIG. 3, two sheets 32, 34 of plane polarised material, for example sheets of plane polarised glass or quartz, are located adjacent one another. An actuator arrangement 36 is provided to control the angular position of one of the sheets relative to the other to control the orientation of the axes of polarisation of the two sheets. It will be appreciated that when the actuator arrangement 36 holds the sheets 32, 34 such that their axes of polarisation are perpendicular to one another, then the shutter arrangement is of substantially opaque form, movement of the sheets relative to one another such that their axes of polarisation lie substantially parallel to one another resulting in the shutter arrangement becoming substantially transparent.

In the arrangements illustrated hereinbefore, it will be appreciated that as the shutter arrangement 18 is located permanently adjacent the light source 12, the shutter arrangements 18 will be subject to high levels of heat. In order to minimise the risk of damage to the shutter arrangements 18 due to the application of such high heat levels, if desired the housing 10 may have associated therewith a cooling arrangement arranged to force air or water over or past the shutter arrangements 18 to dissipate the heat absorbed thereby, in use.

Although in the description hereinbefore the shutter arrangement is described as being located across an opening formed in a housing, it will be appreciated that this need not be the case, the important requirement being that the shutter is so located relative to the light source and the medium to be irradiated that the shutter controls the irradiation of the medium without requiring switching of the light source between its on and off conditions.

Any of the shutters or shuttered light sources described hereinbefore may be controlled by any suitable technique to ensure that irradiation of the target area occurs only at the desired time and, where appropriate, to control the parts of the target area which are irradiated or to control the intensity of irradiation of various parts of the target area. The shutters or shuttered light sources may be controlled, for example, by computer using software to relate a digital raster image, or the output of RIP raster image processing or other similar techniques for creating or processing digital images to the timing, power or polarisation of the individual pixels of the shutter to allow variation of the UV curing dose over parts of the image as the image is moved relative to the shutter or shuttered light source, in use.

It will be appreciated that the invention is not restricted to the specific arrangements described hereinbefore, and that a number of modifications may be made within the scope of the invention.

1. A shutter comprising a body switchable between a substantially opaque condition and a substantially transparent condition, relative to a predetermined frequency of radiation.

2. A shutter according to claim 1, wherein the body comprises two plane polarised elements, one of which is moveable relative to the other to switch the shutter between its substantially opaque and substantially transparent conditions.

3. A shutter according to claim 1, wherein the shutter is a solid state shutter.

4. A shutter according to claim 3, the solid state shutter comprising a plane polarised element and a medium, the polarisation of which can be switched to control whether the shutter is substantially opaque or substantially transparent.

5. A shutter according to claim 4, wherein the medium comprises a layer of a liquid crystal material, a control system being provided for controlling the current or voltage applied to the liquid crystal material to thereby control the orientation of the crystals.

6. A shutter according to claim 5, further comprising a second plane polarised element, the controllable medium being located between the plane polarised elements.

7. A shutter according to claim 5, wherein the control system is arranged to allow parts of the shutter to be controlled independently of other parts thereof, such that the shutter may, at any given time, include one or more areas which are substantially opaque and one or more areas which are substantially transparent.

8. A shutter according to claim 1, further comprising a cooling system for the shutter.

9. A shuttered light source comprising a light emitting device arranged to irradiate a target area, and a shutter as claimed in claim 1 located between the light emitting device and the target area.

10. A light source as claimed in claim 9, wherein the light emitting device is arranged to emit ultraviolet light.

11. A light source as claimed in claim 9, comprising a housing having an opening formed therein, the light emitting device being located within the housing, the shutter being located across or adjacent the opening.

12. A shuttered light source having a filter through which at least a proportion of the radiation emitting by the light source passes, the filter being graduated such that the intensity of radiation incident upon one part of a target area differs from at another part of the target area.

13. A light source as claimed in claim 12, wherein the filter comprises a shutter according to claim 1.

14. A light source as claimed in claim 12, wherein the filter comprises a transparent substrate part or parts of which has or have been treated, for example by printing or etching, to render it or them less transmissive or opaque.

15. (canceled)

16. (canceled)
